(19) United States
(12) Patent Application Publication
(10) Pub. No.: US 2024/0273547 A1
(43) Pub. Date: Aug. 15, 2024

(54) Customer-Enabled Bank Platform For Use with Carbon Calculator

(71) Applicant: The Boston Consulting Group, Inc., Boston, MA (US)

(72) Inventors: Anne Friederike Kleppe, Jena (DE); Daniel Lohner, Heidelberg (DE); Eriola Beetz, London (GB)

(21) Appl. No.: 18/430,096

(22) Filed: Feb. 1, 2024

Related U.S. Application Data
(60) Provisional application No. 63/484,008, filed on Feb. 9, 2023.

(51) Int. Cl. G06Q 30/018

(52) U.S. Cl. CPC G06Q 30/018

(57) ABSTRACT

Described are computer-implemented techniques that include accessing internal bank data for a customer, where the internal bank data includes at least one of credit card transactions, debit account transactions, credit memos, or customer identifying information for the customer and executing one or more operations that use accessed data to identify sources of carbon emissions for a location corresponding to the customer. The techniques also include accessing satellite imagery, soil quality maps, climate maps, agricultural-marketer data, and business information to estimate total area under cultivation and crop mix for the location corresponding to the customer and apply the internal bank data and the estimate of total area under cultivation and the estimate of the crop mix to a carbon calculator to provide carbon emission estimates.

### BACKGROUND

This description relates to use of carbon emission calculators.

Financial institutions are positioning themselves as trusted partners especially for small and mid-sized enterprises (SMEs) to assist them with reducing and understanding their carbon emissions (e.g., carbon dioxide and/or Carbon Dioxide Equivalent (CO2e)). To do so, financial institutions seek to provide their customers with tools to quantify their carbon footprint or other sustainability metrics. There are many existing carbon calculator tools for SMEs already, but all of them require granular data inputs by the customers before providing a value-add to the customer.

### SUMMARY

One of the features that these known carbon calculator tools have in common is that the carbon calculator tools require a customer to provide a significant amount of data inputs. Some of these data inputs require some effort to gather and the tools generally give only minimal support for obtaining all relevant data inputs. Examples of data inputs required include energy consumption, a detailed breakdown of fields, crops planted on the fields, an amount fertilizer and type of fertilizer used, soil types, climate information, etc

According to an aspect, a computer-implemented method includes accessing, by a computer, internal bank data for a customer, where the internal bank data includes at least one of credit card transactions, debit account transactions, memos of client conversations, or customer identifying information for the customer, executing one or more operations that use at least one of the credit card transactions, the debit account transactions, or the credit memos to identify sources of carbon emissions for a location corresponding to the customer, accessing satellite imagery, soil quality maps, climate maps, agricultural—marketer data, and business information to estimate a total area under cultivation and a crop mix for the location corresponding to the customer, receiving a graphical user interface that is prepopulated with estimates that identify sources of carbon emissions, and applying the internal bank data, the estimate of the total area under cultivation, and the estimate of the crop mix to a carbon calculator to provide carbon emission estimates.

One or more of the following embodiments or other embodiments disclosed herein may be included with the above aspect.

The method further includes receiving inputs that update sources of carbon emissions. The method further includes applying the received inputs to the internal bank data, the estimate of the total area under cultivation, and the estimate of the crop mix to provide carbon emission estimates.

The provided carbon emission estimates and the estimate of the crop mix are packaged in a customer carbon profile data structure. The data from the customer carbon profile data structure are rendered in the graphical user interface. The graphical user interface depicts crops planted and acreage planted for the crops. The graphical user interface further depicts emission breakdown by source.

Other aspects include computer program products and computer implemented methods.

One or more of the above aspects may provide one or more of the following advantages.

The described carbon calculator tool is preloaded with a significant amount of data inputs. These data inputs include a detailed breakdown of fields, and crops planted on the fields, an amount fertilizer and type of fertilizer used, energy consumption, soil types, climate information, etc.

The described tool leverages existing financial institutional data such as bank data and combines the existing bank data for a customer with data from external data sources to pre-fill a customer carbon profile data structure that can be input into any of existing carbon emission calculators or future planned carbon emission calculators (or calculators of further sustainability metrics). The tool provides an outside-in estimate and provides value-added benefits to the customer. The customer need not provide their own data input into existing carbon emission calculators or future planned carbon emission calculators.

To get started with the tool, the customer may validate and update the customer data to make the calculations more accurate. Any of a broad range of existing carbon calculators including “generic” calculators can be used. More broadly speaking the platform is suitable for service companies as well as industry-specific calculators that are dedicated to serving a particular industry, e.g., agriculture.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a data processing system.

FIGS. 2-6 are screenshots taken from a graphical user interface.

FIG. 7 is a diagram depicting a profile generation processing.

FIGS. 8 and 9 are diagrams depicting a profile generation processing.

FIGS. 10-13 are diagrams depicting alternative examples.

FIG. 14 is a diagram depicting an alternative profile generation processing example.

FIGS. 15 and 16 are diagrams depicting profile generation processing for the alternative profile generation processing example.

FIG. 17 is a diagram depicting a distributed computing environment implementation.

FIG. 18 is a diagram depicting a computer system.

### DETAILED DESCRIPTION

As used herein the term “carbon emissions” refers to either carbon dioxide and/or carbon dioxide equivalent (CO2e).

As used herein the term “customer” refers to a customer of a financial institution. One example of a customer is a farmer. An agricultural example will be used to describe the subject matter. However other examples can be used and will be described below.

As used herein the term “financial institution” refers to an institution that possesses existing customer data that can be combined with data from external data sources to pre-fill a customer carbon profile data structure. An example of a “financial institution” is a bank that holds records of credit card transactions and other bank transactions that can be used to identify payments for fertilizer, farm supplies, electricity, and fossil fuels, etc. Other records of interest include unstructured credit memos that typically include a comprehensive description of the farm.

As used herein the term “financial institution user” refers to an employee or agent of such a financial institution.

As used herein the term “emissions caused by the customer's activities” refers to output (either carbon dioxide and/or carbon dioxide equivalent (CO2e)) from a conventional carbon emission calculator based on a customer carbon profile data structure.

As used herein the term “customer carbon profile data structure” refers to a data structure that is output to a conventional carbon emissions calculator. The customer carbon profile data structure can be based on either carbon dioxide and/or carbon dioxide equivalent (CO2e) emissions. Carbon dioxide equivalent (CO2e) emissions will be used herein. The term “customer carbon profile data structure” is derived by applying advanced analytics to records of credit card transactions and other financial transactions that can be used to identify payments for fertilizer, farm supplies, electricity and fossil fuels, etc., combined with external data from external data sources such as emissions reported by third party providers (TTP), and modelled emissions based on external data sources at a physical asset level, to provide a comprehensive description of CO2e emissions from a customer's property, such as a farm.

The technique disclosed herein produces a customer carbon profile data structure that can be inputted into a conventional carbon calculator, which also includes the external data from plural external data sources. The advanced analytic models are used to derive the customer carbon profile data structure from the customer data and external data. The customer carbon profile data structure is used as an input source to a conventional carbon emission calculator to derive emissions caused by the customer's activities. The customer carbon profile data structure provides to the carbon calculator current bank data, while dynamically adapting to new information. External data sources can include emissions reported by third party providers (TTP), as well as modelled emissions based on external data sources at a physical asset level, and available and proxy emissions based on country, industry, and technology specific averages.

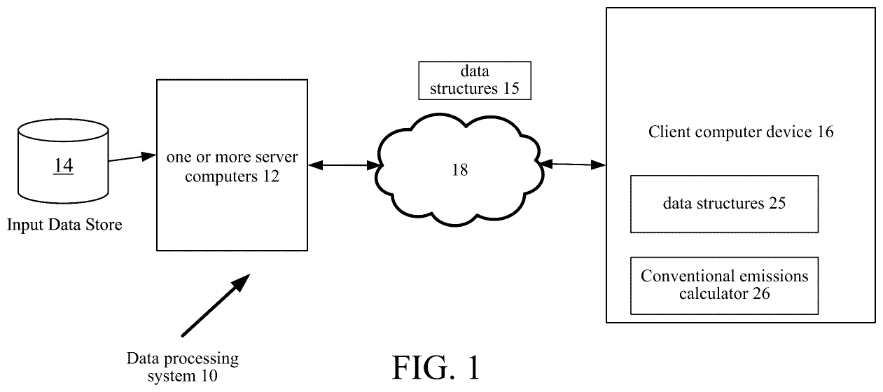

Referring now to FIG. 1, a data processing system 10 is shown. The data processing system 10 includes one or more server computers 12, input data stores 14 and a client computer device 16 coupled via a network 18, e.g., the Internet or a private network to the one or more server computers 12. The input data store 14 is a non-transitory hardware storage device that is either persistent, i.e., data remains when power is removed, or non-persistent, i.e., data is lost when power is removed. The input data store 14 stores internal bank data that define “items” from which advanced analytics can calculate carbon emissions. The input data store 14 has the internal bank data arranged into data structures 15. The data structures 15 include fields that have customer identifiers that define a recipient of the item. For example, the internal bank data can include customer credit card transactions, debit account transactions, credit memos, and similar items which identify payments made by the customer, with fields defining customer identifiers (CID), for items that contribute to carbon emissions. Such items include purchases of fertilizer, farm supplies, electricity, and fossil fuels.

The client computer device 16 can be any computing device that includes a display and ideally which can perform calculations or at a minimum receive input data for some embodiments of the client computer device 16. Examples of client computer device 16 include a smart phone, a tablet computer, a lap top computer, a desktop computer, etc.

Advanced analytics prepopulates a customer carbon profile data structure(s) 25 based on data from the data structures 15 to provide to the conventional carbon emissions calculator 26. The customer carbon profile data structure 25 is configured according to the conventional carbon emissions calculator 26 used. As such, it is not necessary to describe in any detail the structure of the customer carbon profile data structure 25, as that structure will vary according to the calculator that is used. The customer carbon profile data structure 25 is used as an input to the conventional carbon emission calculator 26 to derive emissions caused by the customer's activities. The advanced analytics operations that prepopulate the customer carbon profile data structure(s) 25 from the data from the data structures 15 can occur on the one or more server computers 12 and/or the client computer device 16.

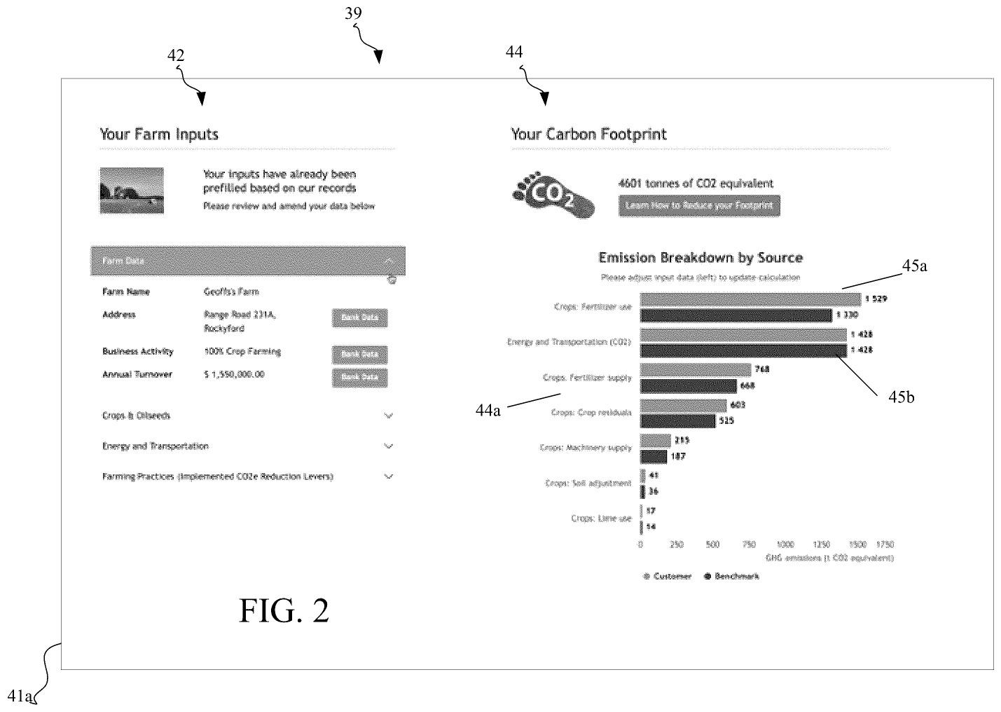

Referring now to FIG. 2, a screenshot 41a of an exemplar user interface 40 that is part of a customer carbon profile tool 39 is shown. The screenshot 41a is displayed, e.g., on a screen (not referenced) of the client computer device 16 and is prepopulated with data based on applying advanced analytics to internal bank data that define “items” from which a conventional carbon calculator calculates carbon emissions. The carbon calculator is a conventional type of carbon calculator.

The screenshot 41 a includes location data 42 and carbon footprint data 44, generally of the customer's operation, e.g., the customer's farm. The carbon footprint data 44 displays emission breakdown by source in the form of a bar graph 44a. In the bar graph 44a the emissions caused by the customer's activities 45a are displayed in relation to benchmark emissions 45b. The benchmark emissions 45b are derived from any industry standard benchmark. Benchmark emissions are calculated using the input parameters of an average customer comparable to the customer (e.g., the customer's peers).

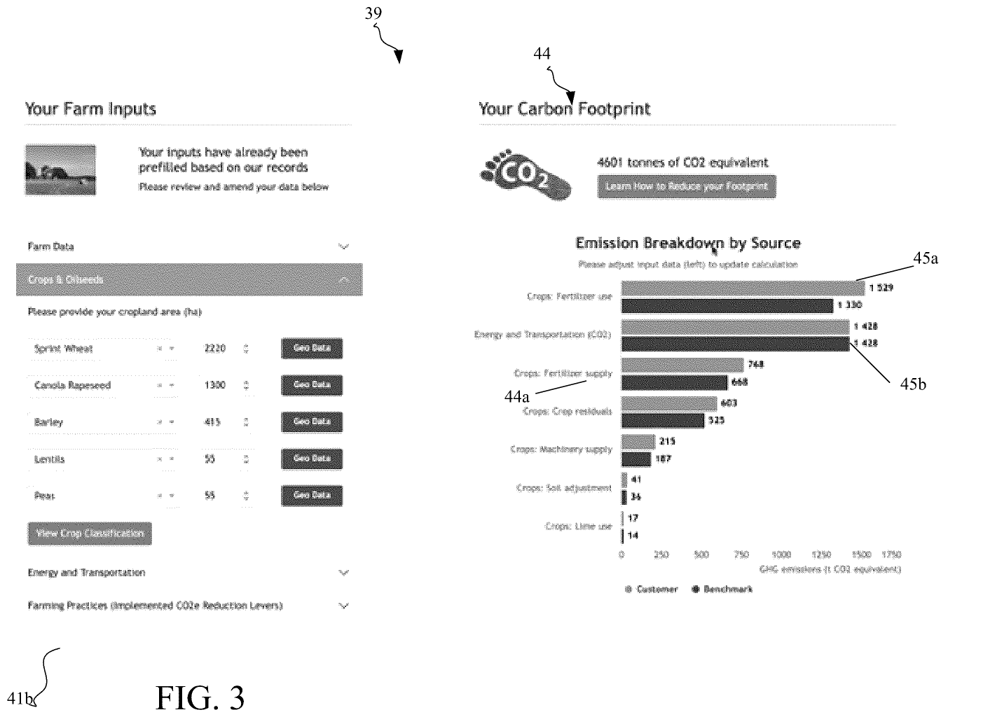

Referring now to FIG. 3, another screenshot 41b of the exemplar user interface 40 that is part of the customer carbon profile tool 39 includes crops and fields with fields for crop types and planting areas in e.g., hectares. The screenshot 41b is prepopulated with crop types and areas, e.g., spring wheat 2220 ha (hectares) canola rapeseed 1300 ha; barley 415 ha; lentils 55 ha; and peas 55 ha. Also shown are sources of the data. Here the source is delineated as geo data. Again, based on applying advanced analytics to the crop types and areas data, the advanced analytics prepopulates the fields in a conventional carbon emissions calculator to calculate the carbon emissions caused by the customer's activities. The screenshot 41b shows emission breakdown by source. The emission breakdown by source is displayed in the form of the bar graph 44a (as in FIG. 2). In the bar graph 44a, the emissions caused by the customer's activities 45a are displayed in relation to the benchmark emissions 45b. Crop types are derived from satellite images of an area surrounding the customer's farm that has been processed through an advanced analytics model to identify which crops are planted. Combining this with yields and commodity prices provides a very detailed insight into the farm operations.

Screenshot 41b allows the financial institution user or customer to adjust the amounts of crop types and areas actually planted to obtain a more accurate calculation of emissions caused by the customer's activities or to adjust for other scenarios. For example, the financial institution user or customer may adjust the amount of spring wheat planted to 2400 ha and change peas 55 ha to beans 55 ha. These adjustments (not shown) are reflected in the carbon footprint data 44 by changes (not shown) to the emissions caused by the customer's activities indicated by source.

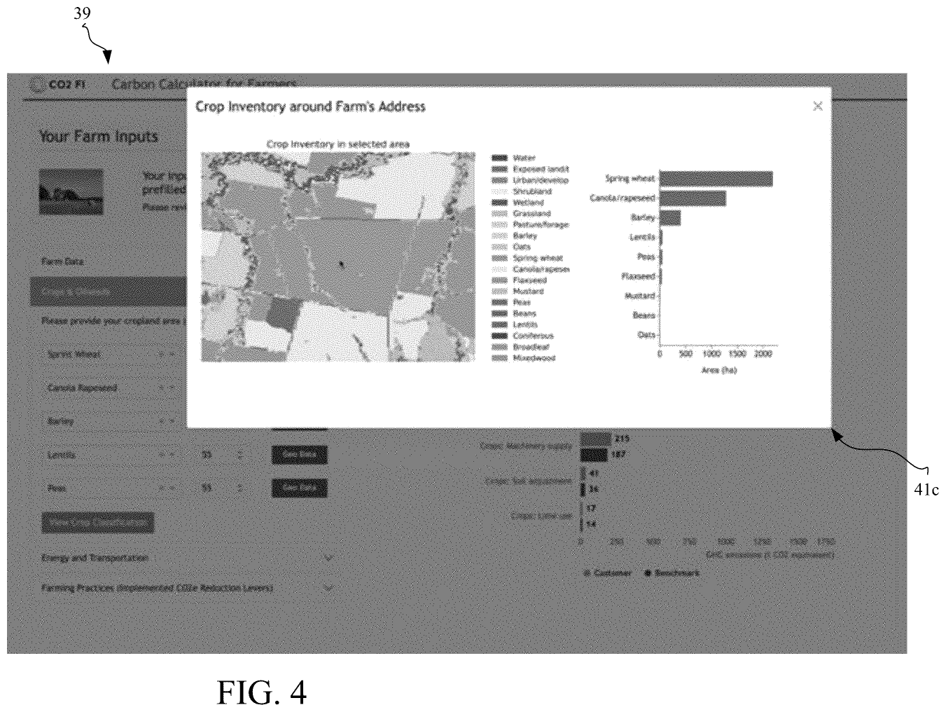

Referring now to FIG. 4, another screenshot 41c of the exemplar user interface 40 that is part of the customer carbon profile tool 39 in the form of a popup window is shown. This screenshot 41c depicts crop types in areas about the customers address. The screenshot 41c is positioned over the screenshot 41b (FIG. 3) with the screenshot 41b in the background shaded in gray. Screenshot 41c depicts a map 46a, an index 46b, and a graph 46c. The map depicts an area about the customer's address, whereas the index 46b depicts a listing of crops as well as other topographical features that are present in region defined by the map 13a. The graph 46c depicts various ones of the crops according to planted hectares, in the index 46b, as planted in the region defined by the map 46a.

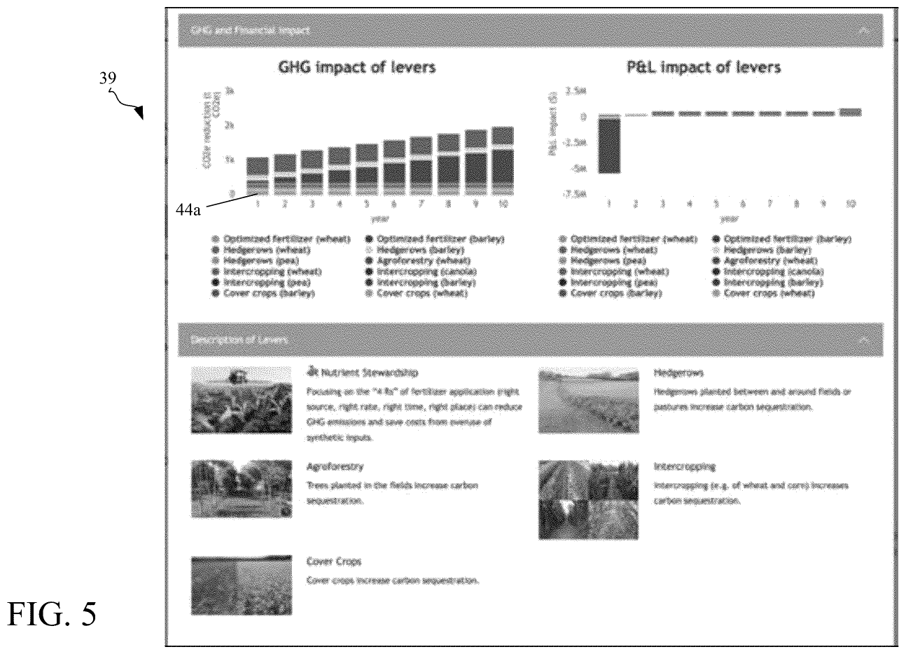

Referring now to FIG. 5, another screenshot 41d of the exemplar user interface 40 that is part of the customer carbon profile tool 39 in the form of a popup window is shown. This screenshot 41d depicts impact of various levers that can be used to reduce the emissions caused by the customer's activities. The screenshot 41d may be positioned (not shown) over the screenshot 41b (FIG. 3), with the screenshot 41b in the background shaded in gray, as in FIG. 4. Screenshot 41d depicts two graphs 48a, 48b and a narrative section 18c. Graph 48a depicts GHG (greenhouse gas) emission impact of levers over a period of time, e.g., 10 years. Any period of time can be used. Graph 48a also shows an index 48a′ of different planting strategies. Examples of different planting strategies include use of “optimized fertilizer” and “hedgerows (wheat)” and “hedgerows (pea).” Graph 48b shows profit and loss (P&L) impacts on a yearly basis, generally at the same scale as graph 48a. The narrative section 18c depicts an explanation of the various planting strategies depicted in graph 48a.

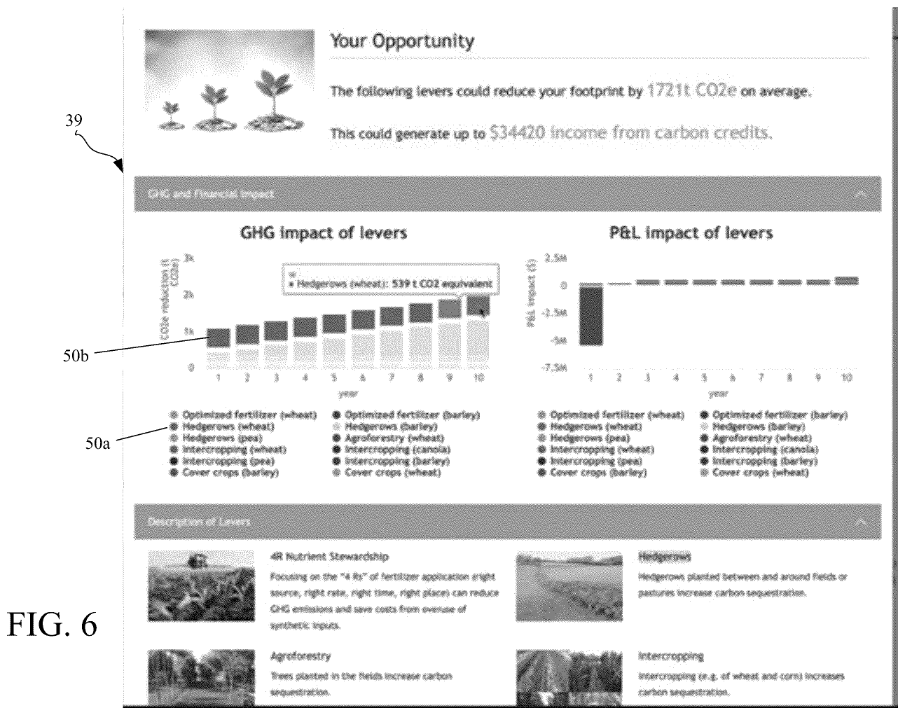

Referring now to FIG. 6, another screenshot 41e of the exemplar user interface 40 that is part of the customer carbon profile tool 39 in the form of a popup window is shown. This screenshot 41e depicts impact of a specific lever that can be used to reduce the emissions caused by the customer's activities. The screenshot 41e may be positioned (not shown) over the screenshot 41b, with the screenshot 41b in the background shaded in gray, as in FIG. 4. Screenshot 41e depicts two graphs 49a, 49b and a narrative section 49c. Graph 48a depicts GHG (greenhouse gas) emission impact of a single lever 50a“hedgerows (wheat)” over a period of time, e.g., 10 years. Any period of time can be used. Graph 49a also shows an index 49a′ of different planting strategies, with the impact 50b of the single lever 50a shown in the graph 49a. Graph 49b shows profit and loss (P&L) impacts on a yearly basis, generally at the same scale as graph 48a for adopting the single lever 50a “hedgerows (wheat).” The narrative section 18c depicts an explanation of the various planting strategies depicted in graph 49a, with the “hedgerows” highlighted.

Tables I and II below show descriptions of analytic components for prefilling customer carbon profile data structures. These tables are specifically derived for an agriculture example. Other examples are feasible.

| | | | Required Data |
|---|---|---|---|
| Module | Description | Analytics | Sources |
| benchmark | provides input factors | revenue | agriculture census |
| module - | for a comparable farm. | regression, | data within given |
| census data | serves two purposes: a) | lookup | region |
| (ver. 1) | to compute benchmark | | |
| | carbon footprint (based | | |
| | on inputs) b) as a starting | | |
| | point for the footprint | | |
| | calculation (fallback) | | |
| benchmark | provides input factors + | revenue | benchmark database |
| module - | carbon footprint for a | regression, | built based on |
| collected | comparable farm. same | nearest | collected financial |
| data (ver. 2) | purpose as ver. 1. | neighbor | institution user or |
| | | | customer data from |
| | | | tool usage |
| geo analysis | based on geocoded address of | geo encoding | annual crop |
| module | the farmer provides insights | geo analysis | inventory, satellite |
| | on crops (from crop | | data on crops, soil |
| | inventory), soil properties, | | databases, climate |
| | climate + land use change | | data, . . . |
| credit memo | identifies and extracts | natural | credit memos, |
| module | relevant information on input | language | appraisals for land |
| | factors from unstructured | processing | mortgage, |
| | bank data, e.g., credit memos, | (NLP) | synergy collateral |
| | collateral data, | | system, . . . |
| spend analysis | analyze spend of the customer | named entity | debit transactions |
| module | to identify a) input factors | recognition, | from credit card, |
| (Transactions) | (e.g., spend on oil, energy | supervised | corporate current |
| | consumption) b) spend-based | learning, | account + profit and |
| | emission factors (e.g., 100% | business rules | loss data to enrich |
| | renewable power) | | |

External tool outputs are input factors for a conventional carbon emissions calculator. The outputs are formatted to industry standards or non-standard according to the emission calculator selected. Outputs for required data sources for financial institution user or customer inputs are blank. For “plausibility checks” the output is “plausibility for each financial institution user or customer input.”
1. A collection of name/value pairs provides as an object, record, struct, dictionary, hash table, keyed list, or associative array.
2. An ordered list of values generally provided as an array, vector, list, or sequence.

Other tools may be used.

API stands for application programming interface.

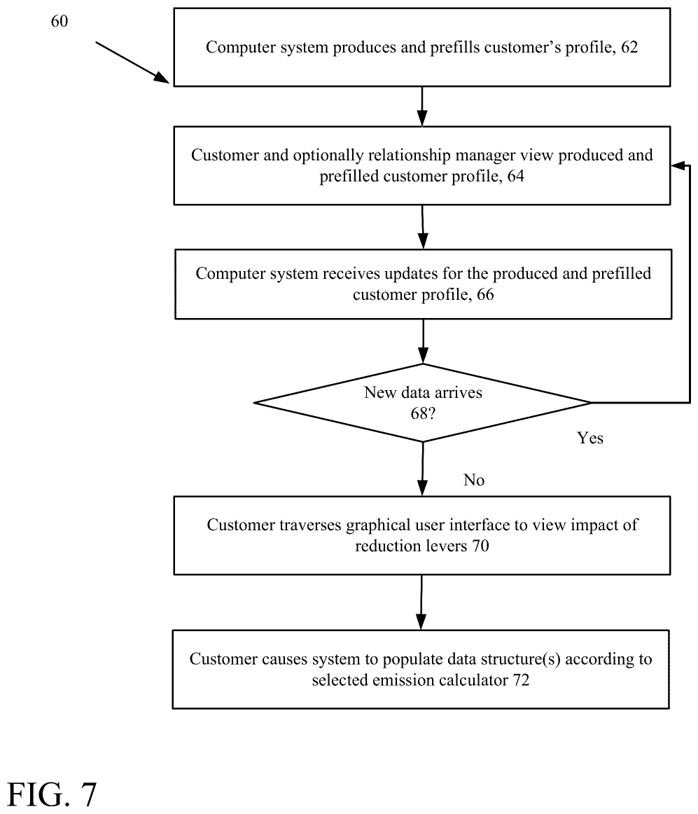

Referring now to FIG. 7, a process 60 is shown. In process 60a computer system produces and prefills customer's profile, 62. Thereafter, a customer and optionally relationship manager view the produced and prefilled customer carbon profile data structure, 64. When the computer system receives updates for the produced and prefilled customer carbon profile data structure, 66, these updates can originate from financial institution user or customer inputs, such as changes to planted crops or planted acreage, or from external input data received by the computer subsequent to uploading the profile. When the process receives 68 the new data, the new data is sent to update the produced and prefilled customer carbon profile data structure, i.e., back to item 64. When new data is not received, or at other instances subsequent to receiving the customer carbon profile data structure, the customer and optionally the relationship manager can traverse the graphical user interface to view impact of reduction levers 70. At some point, the system populates data structure(s) according to selected emission calculator 112 and sends these data structures to the selected emission calculator to provide the emissions caused by the customer's activities.

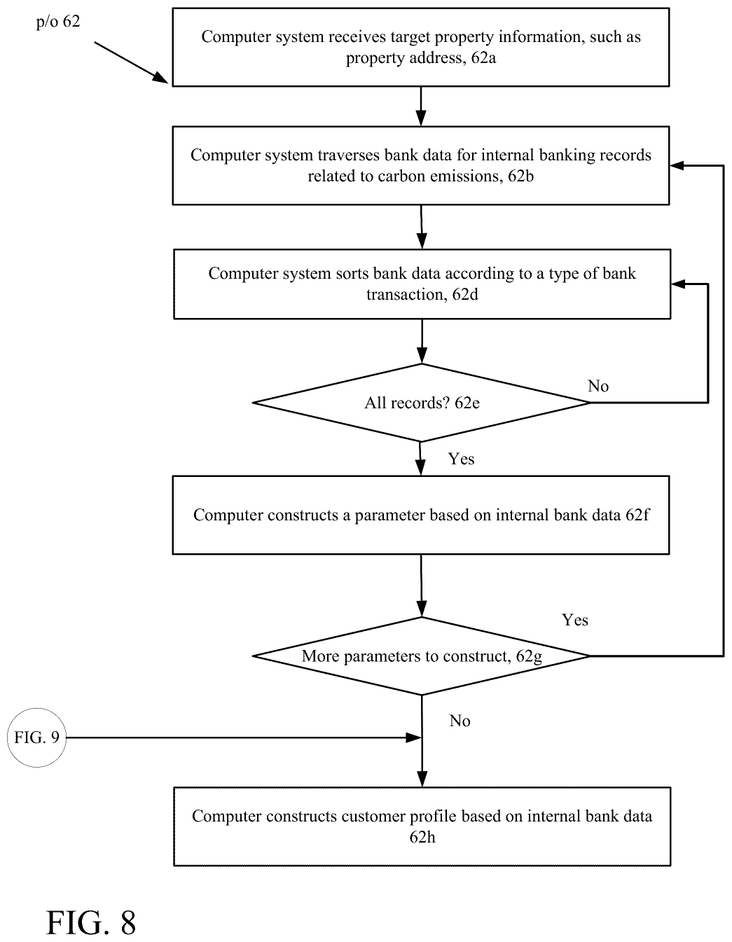

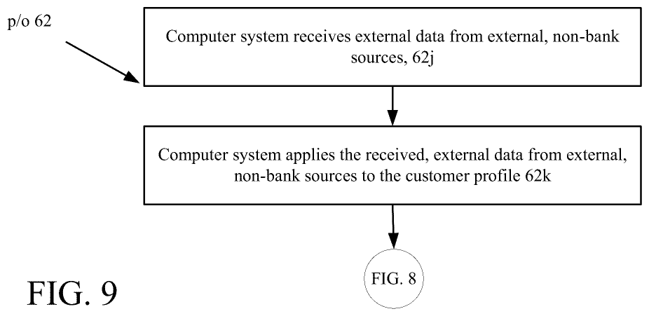

Referring now to FIGS. 8 and 9, details on the process 62 to build the customer carbon profile data structure are shown. The computer system receives 62a target property information, such as property address. The computer system traverses 62b bank data for internal banking records related to carbon emissions. The computer system sorts 62d bank data according to a type of bank transaction. When the computer system has all records of transactions 62e, the computer system constructs a parameter based on internal bank data 62f. When the computer determines that there are more parameters to construct 62g, the process 62 traverses bank data for internal banking records related to carbon emissions, 62b for the next parameter. When there are no more parameters to construct, 62g, the computer system can construct 62h the customer carbon profile data structure based on internal bank data. Optionally, as shown in FIG. 9, the computer system receives external data from external, non-bank sources, 62j, applies the received, external data from external, non-bank sources to the customer carbon profile data structure 62k and thereafter the computer system constructs 62h the customer carbon profile data structure based on internal bank data and optional the external data from external, non-bank sources.

### Other Examples

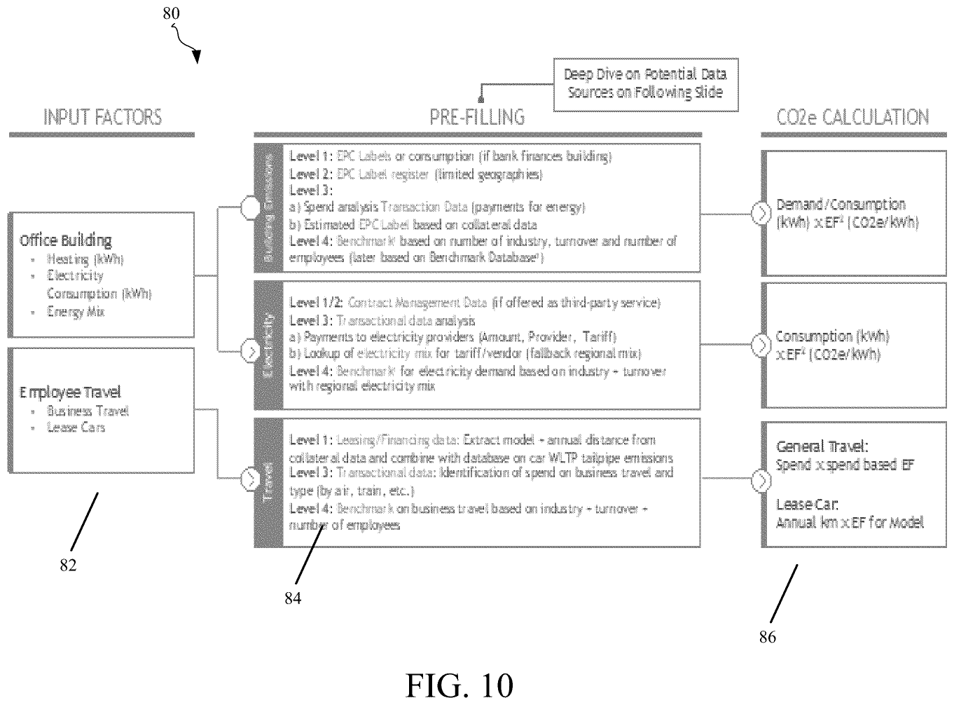

Referring now to FIG. 10, a generic calculator process 80 is shown. In process 80 a computer system receives input factors 82 such as office building, with sub-factors, including heating, electricity, and energy mix, i.e., types of energy employed by the office. A second input factor is employee travel, e.g., business travel and leased cars. The process 80 prefills the office's profile, as shown in FIG. 10 at 84. Thereafter, the prefilled office profile is used 86 by the CO2e calculator to provide a CO2e calculation.

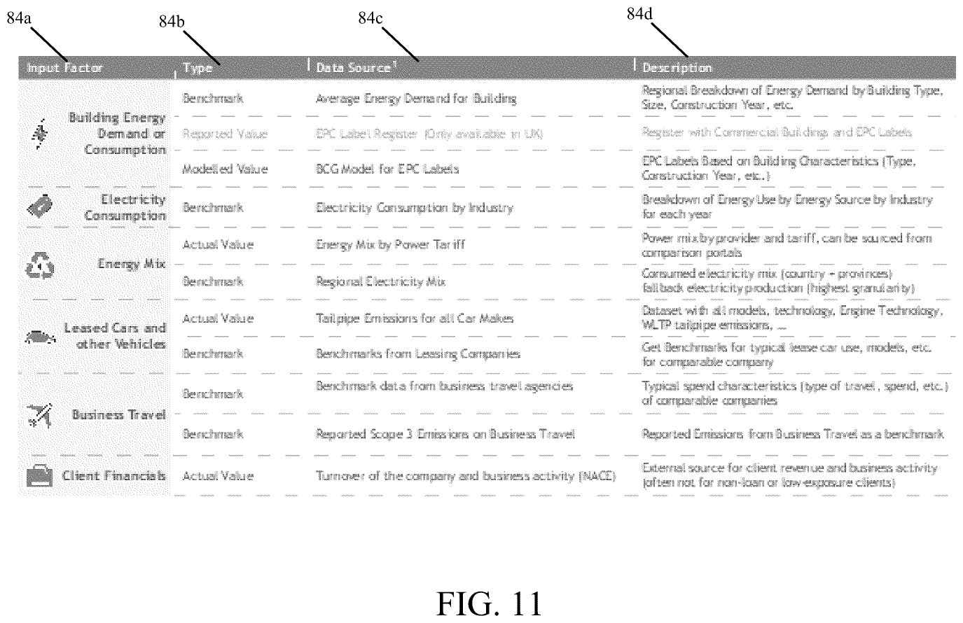

Referring now to FIG. 11, prefill process 84 examines input factors 84a, reporting type 84b, data source 84c, and description 84d. The input factors 84a are generally as in FIG. 10, the reporting type 84b in FIG. 11, refers to the type of reporting, e.g., benchmark, modeled value, actual value, and reported value. The data source 84c refers to the potential sources of input data. For example, for the input factor 84a “energy mix” there may be two reporting types 84b “actual value” and benchmark.” The “energy mix” “actual value” can be sourced from “energy mix by power tariff” and the “benchmark” may be sourced from “regional electricity mix.” The description explains the sourcing. For example, the “energy mix” “actual value” can be described as “power mix by provider and tariff, can be sourced from comparison portals,” and “energy mix” “benchmark” can be described as “consumed electricity mix.”

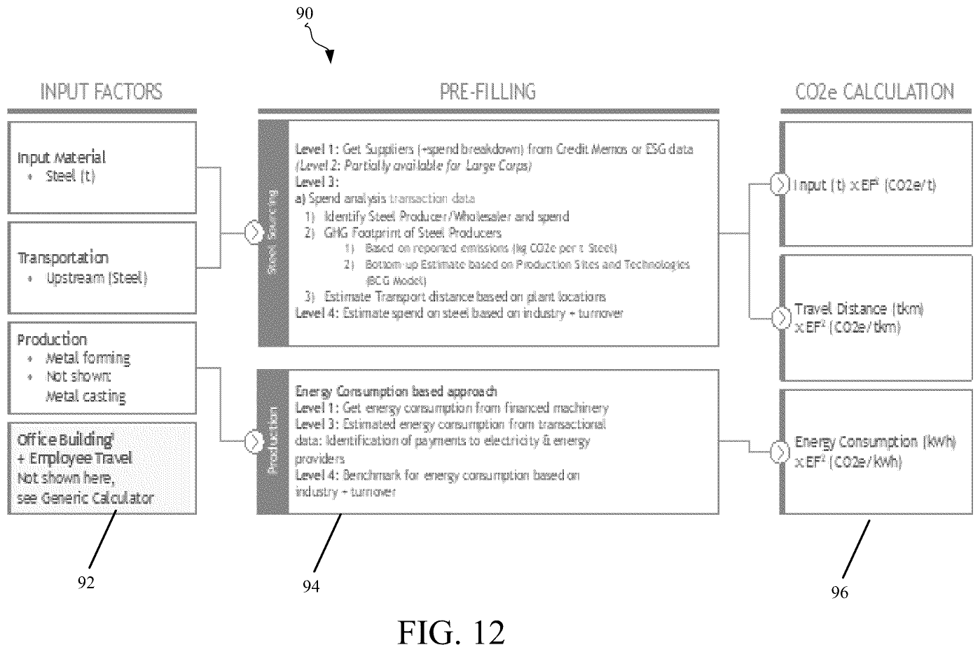

Referring now to FIG. 12, another calculator process 90 is shown. In process 90, a computer system receives input factors 92 such as input material, with sub-factors, being material type, e.g., steel, (or aluminum, etc.). Process 90 receives a second input factor “transportation,” e.g., upstream of the material type. A third input factor is “production” with sub-factors “metal forming” and “metal casing.” A fourth input factor is “Office Building,” as described in FIGS. 10 and 11.

The process 90 prefills the metal processing company's profile, as shown in FIG. 12 at 94. Thereafter, the prefilled profile is used by the CO2e calculator to provide a CO2e calculation 96.

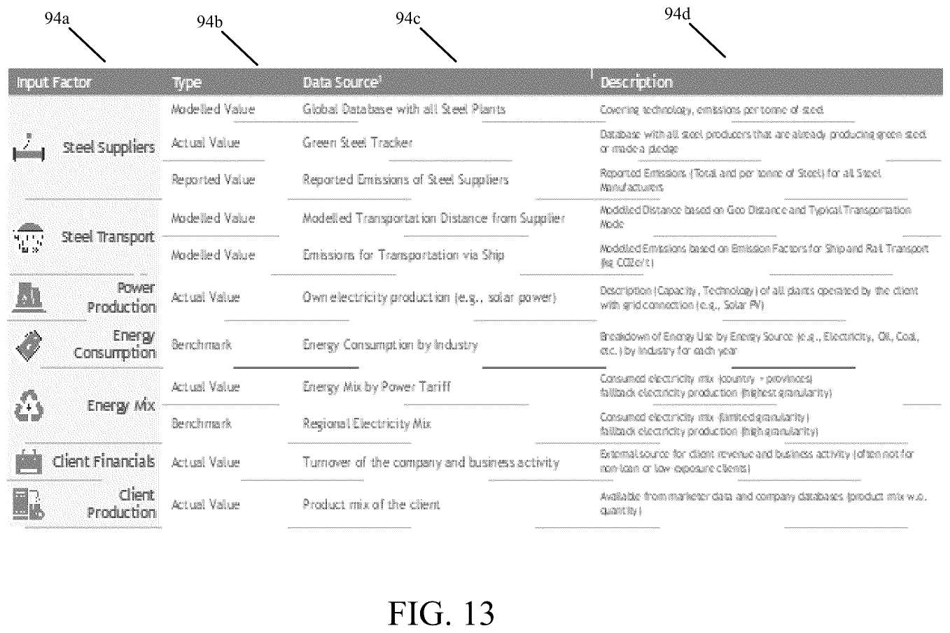

Referring now to FIG. 13, prefill process 84 examines input factors 94a, reporting type 94b, data source 94c, and description 94d. The input factors 94a are generally as in FIG. 13, the reporting type 84b in FIG. 13, refers to the type of reporting, e.g., benchmark, modeled value, actual value, and reported value. The data source 94c refers to the potential sources of input data. For example, for the input factor 94a “steel suppliers” there may be two reporting types 94b “modified valve” and “actual value.” The “steel suppliers” “modified value” can be sourced from “global database with all Steel Plants” and the “actual value” may be sourced from “green steel tracker.” The description 94d explains the sourcing, as shown.

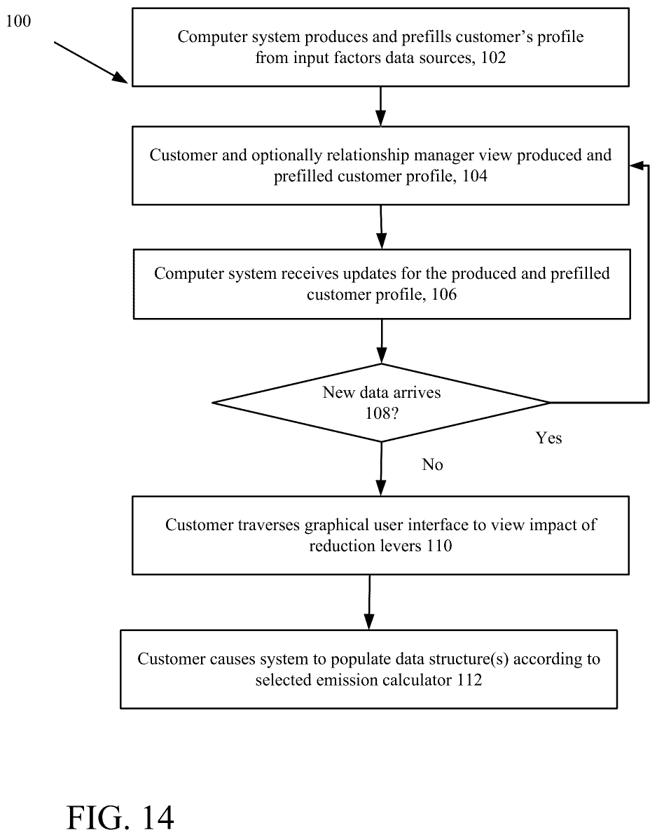

Referring to FIG. 14, a process 100 can be adapted for calculator process 80 or calculator process 90. In process 100 a computer system produces and prefills customer's profile, 102 from input factors. Thereafter, a customer and optionally relationship manager view the produced and prefilled customer carbon profile data structure, 104. When the computer system receives updates for the produced and prefilled customer carbon profile data structure 106, these updates can originate from financial institution user or customer inputs such as changes to planted crops or planted acreage, or from external input data, received by the computer subsequent to uploading the profile. When the process receives 108 the new data, the new data is sent to update the produced and prefilled customer carbon profile data structure, i.e., back to item 104. When new data is not received or, at other instances, subsequent to receiving the customer carbon profile data structure, the customer and optionally the relationship manager can traverse the graphical user interface to view impact of reduction levers 110. At some point, the system populates data structure(s) according to selected emission calculator 112 and sends these data structures to the selected emission calculator to provide the emissions caused by the customer's activities.

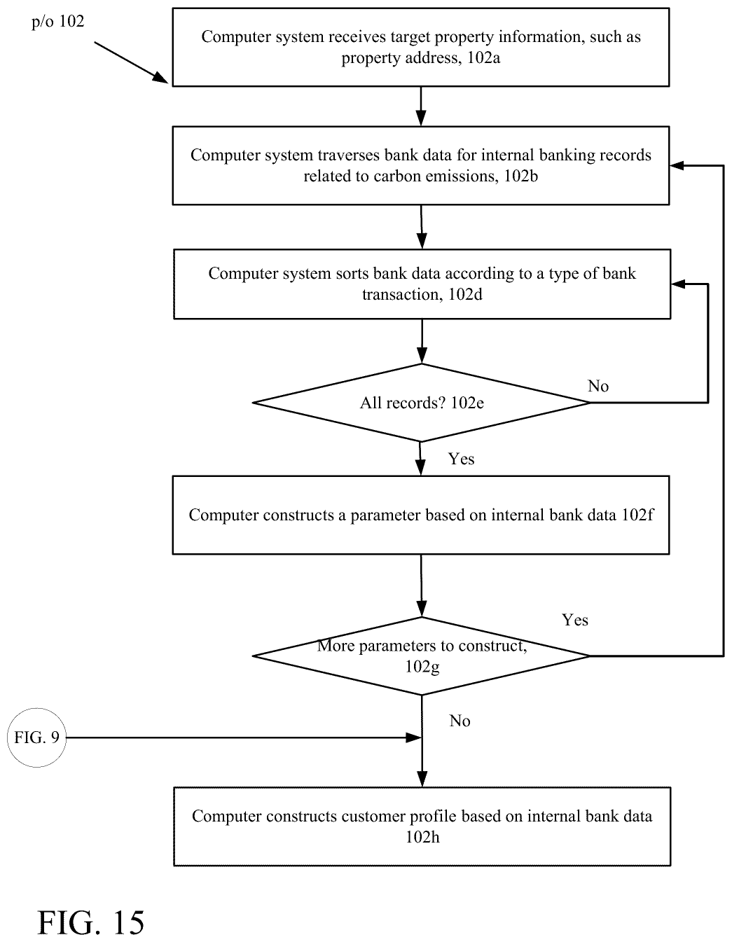

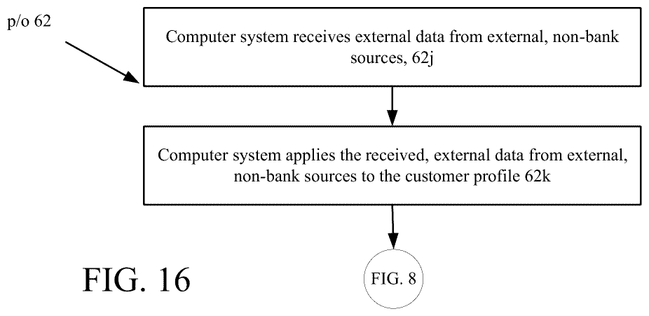

Referring now to FIGS. 15 and 16, details on the process 102 to build the customer carbon profile data structure are shown. The computer system receives 102a target property information, such as office or plant address. The computer system traverses 102b bank data for internal banking records related to carbon emissions at the office or plant address. The computer system sorts 102d bank data according to a type of bank transaction. When the computer system has all records of transactions 102e, the computer system constructs a parameter based on internal bank data 102f. When the computer determines that there are more parameters to construct 102g, the process 102 traverses bank data for internal banking records related to carbon emissions, 102b for the next parameter. When there are no more parameters to construct, 102g, the computer system can construct 102h the customer carbon profile data structure based on internal bank data. Optionally, as shown in FIG. 9, the computer system receives external data from external, non-bank sources, 102j, applies the received, external data from external, non-bank sources to the customer carbon profile data structure 102k and thereafter the computer system constructs 102h the customer carbon profile data structure based on internal bank data and optional the external data from external, non-bank sources.

### Example Distributed Computing System Environment

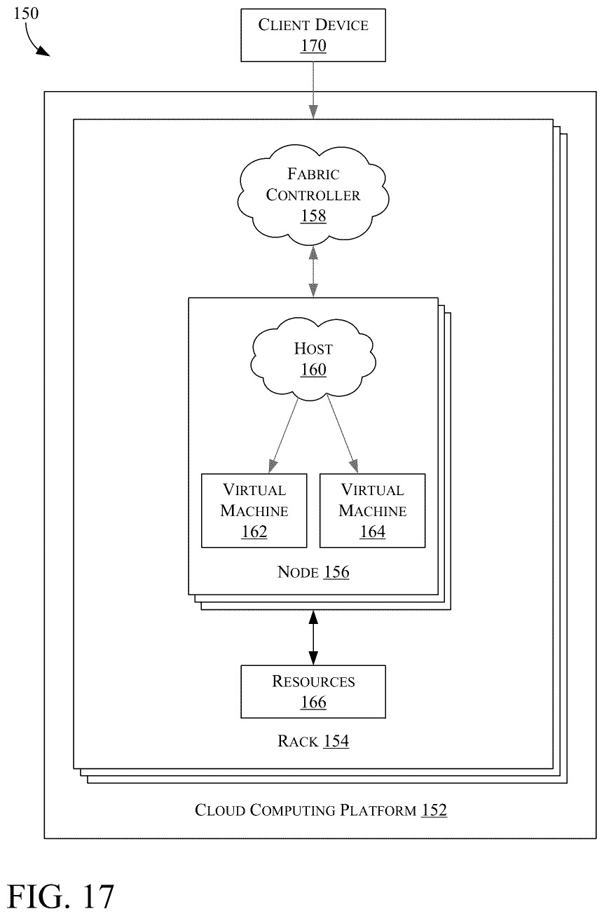

Referring now to FIG. 17, an example of a distributed computing environment 150 is shown. FIG. 17 shows a high-level architecture of a cloud computing platform 152 that can host a technical solution environment, or a portion thereof (e.g., a data trustee environment). It should be understood that, this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The distributed computing environment 150 includes data centers that includes cloud computing platform 152, rack 154, and node 156 (e.g., computing devices, processing units, or blades) in rack 154. The technical solution environment can be implemented with cloud computing platform 152 that runs cloud services across different data centers and geographic regions. Cloud computing platform 152 can implement fabric controller 158 component for provisioning and managing resource allocation, deployment, upgrade, and management of cloud services. Typically, a cloud computing platform 152 acts to store data or data analytics applications in a distributed manner. Cloud computing platform 152 in a data center can be configured to host and support operation of endpoints of a particular service application. Cloud computing platform 152 may be a public cloud, a private cloud, or a dedicated cloud.

Node 156 can be provisioned with host 160 (e.g., operating system or runtime environment) execution a defined software stack on node 156. Node 156 can also be configured to perform specialized functionality (e.g., compute nodes or storage nodes) within cloud computing platform 152. Node 156 is allocated to run one or more portions of a service application of a tenant. A tenant can refer to a customer utilizing resources of cloud computing platform 152. Service application components of cloud computing platform 152 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 156, nodes 156 may be partitioned into virtual machines (e.g., virtual machine 162 and virtual machine 164). Physical machines can also concurrently run separate service applications. The virtual machines or physical machines can be configured as individualized computing environments that are supported by resources 166 (e.g., hardware resources and software resources) in cloud computing platform 152. It is contemplated that resources can be configured for specific service applications. Further, each service application may be divided into functional portions such that each functional portion is able to run on a separate virtual machine. In cloud computing platform 152, multiple servers may be used to run data analytics applications and perform data storage operations in a cluster. In particular, the servers may perform data operations independently but exposed as a single device referred to as a cluster. Each server in the cluster can be implemented as a node.

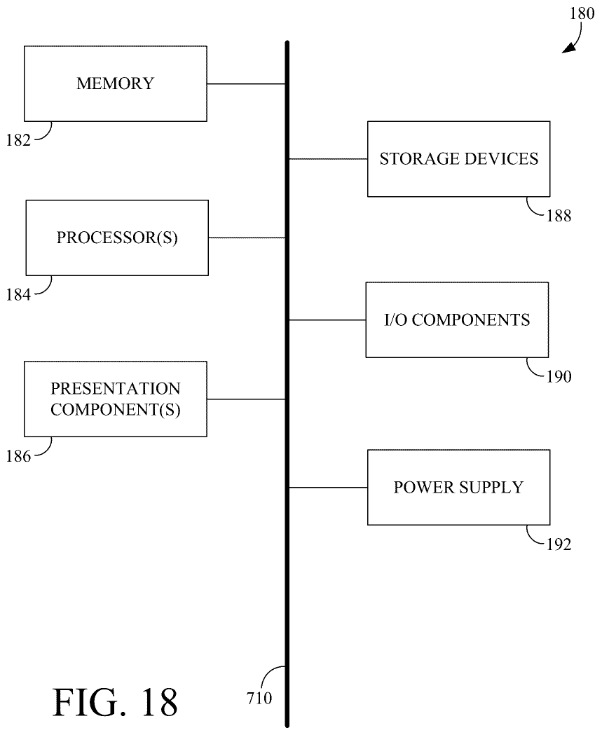

Client device 170 may be linked to a service application in cloud computing platform 152. Client device 170 may be any type of computing device, which may correspond to computing device 180 described with reference to FIG. 18, for example, client device 170 can be configured to issue commands to cloud computing platform 152. In embodiments, client device 170 may communicate with data analytics applications through a virtual Internet Protocol (IP) and load balancer or other means that direct communication requests to designated endpoints in cloud computing platform 152. The components of cloud computing platform 152 may communicate with each other over a network (not shown), which may include, without limitation, one or more local area networks (LANs) and/or wide area networks (WANs).

### Example Computing Environment

Referring to FIG. 18, an example operating environment for implementing embodiments of the present invention is shown and designated generally as computing device 180. Essential elements of a computing device 180 or a computer or data processing system, etc. are one or more programmable processors 184 for performing actions in accordance with instructions and one or more memory devices 182 for storing instructions and data. Generally, a computer will also include, or be operatively coupled, (via bus, fabric, network, etc.,) to input/output (I/O) components 190, e.g., display devices, network/ communication subsystems, etc. and one or more mass storage devices 188 for storing data and instructions, etc., which are powered by a power supply 192.

The features of the markdown improve the functioning of the distributed computing environment and/or the computing device (or computer or data processing system, etc.) by providing the markdown and lifecycle management tool that enables the computing device to maximize margins for every merchant product including new products.

Embodiments can be implemented in digital electronic circuitry, or in computer hardware, firmware, software, or in combinations thereof. Embodiments can be implemented in a computer program product tangibly stored in a machine-readable (e.g., non-transitory computer readable) hardware storage device for execution by a programmable processor; and method actions can be performed by a programmable processor executing a program of executable computer code (executable computer instructions) to perform functions of the invention by operating on input data and generating output. Embodiments can be implemented advantageously in one or more computer programs executable on a programmable system, such as a data processing system that includes at least one programmable processor coupled to receive data and executable computer code from, and to transmit data and executable computer code to, memory, and a data storage system, at least one input device, and at least one output device. Each computer program can be implemented in a high-level procedural or object-oriented programming language, or in assembly or machine language if desired; and in any case, the language can be a compiled or interpreted language.

Suitable processors include, by way of example, both general and special purpose microprocessors. Generally, a processor will receive executable computer code (executable computer instructions) and data from memory, e.g., a read-only memory and/or a random-access memory and/or other hardware storage devices. Generally, a computer will include one or more mass storage devices for storing data files; such devices include magnetic disks, such as internal hard disks and removable disks; magneto-optical disks; and optical disks. Hardware storage devices suitable for tangibly storing computer program executable computer code and data include all forms of volatile memory, e.g., semiconductor random access memory (RAM), all forms of non-volatile memory including, by way of example, semiconductor memory devices, such as EPROM, EEPROM, and flash memory devices; magnetic disks such as internal hard disks and removable disks; magneto-optical disks; and CD_ROM disks. Any of the foregoing can be supplemented by, or incorporated in, ASICs (application-specific integrated circuits).

A number of embodiments of the invention have been described. The embodiments can be put to various uses, such as educational, job performance enhancement, e.g., sales force and so forth. Nevertheless, it will be understood that various modifications may be made without departing from the scope of the invention.

What is claimed is:

1. A computer-implemented method comprises:
accessing, by a computer system, internal bank data for a customer, where the internal bank data includes at least one of credit card transactions, debit account transactions, credit memos, or customer identifying information for the customer;
executing, by the computer system, one or more operations that use at least one of the credit card transactions, the debit account transactions, or the credit memos to identify sources of carbon emissions for a location corresponding to the customer;
accessing, by the computer system, satellite imagery, soil quality maps, climate maps, agricultural-marketer data, and business information to estimate a total area under cultivation and a crop mix for the location corresponding to the customer;
receiving, by the computer system, a graphical user interface that is prepopulated with estimates that identify sources of carbon emissions; and
applying, by the computer system, the internal bank data, the estimate of the total area under cultivation, and the estimate of the crop mix to a carbon calculator to provide carbon emission estimates.

2. The method of claim 1, further comprising:
receiving inputs that update sources of carbon emissions.

3. The method of claim 2, further comprising:
applying the received inputs to the internal bank data, the estimate of the total area under cultivation, and the estimate of the crop mix to provide carbon emission estimates.

4. The method of claim 1, wherein the provided carbon emission estimates and the estimate of the crop mix are packaged in a customer carbon profile data structure.

5. The method of claim 4, wherein data from the customer carbon profile data structure are rendered in the graphical user interface.

6. The method of claim 5, wherein the graphical user interface depicts crops planted and acreage planted for the crops.

7. The method of claim 6, wherein the graphical user interface further depicts a breakdown of carbon emission by source.

8. A computer system comprises:
one or more processors;
memory storing computer instructions for causing the one or more processor to:
access internal bank data for a customer, where the internal bank data includes at least one of credit card transactions, debit account transactions, credit memos, or customer identifying information for the customer;
execute one or more operations that use at least one of the credit card transactions, the debit account transactions, or the credit memos to identify sources of carbon emissions for a location corresponding to the customer;
access satellite imagery, soil quality maps, climate maps, agricultural—marketer data, and business information to estimate a total area under cultivation and a crop mix for the location corresponding to the customer;
receive a graphical user interface that is prepopulated with estimates that identify sources of carbon emissions; and
applying the internal bank data, the estimate of the total area under cultivation. and the estimate of the crop mix to a carbon calculator to provide carbon emission estimates.

9. The computer system of claim 8, further comprising instructions to cause the computer system to:
receive inputs that update sources of carbon emissions.

10. The computer system of claim 9, further comprising instructions to cause the computer system to:
Apply the received inputs to the internal bank data, the estimate of the total area under cultivation, and the estimate of the crop mix to provide carbon emission estimates.

11. The computer system of claim 8, wherein the provided carbon emission estimates and the estimate of the crop mix are packaged in a customer carbon profile data structure.

12. The computer system of claim 11, wherein data from the customer carbon profile data structure are rendered in the graphical user interface.

13. The computer system of claim 12, wherein the graphical user interface depicts crops planted and acreage planted for the crops.

14. The computer system of claim 13, wherein the computer system is linked to a service application in a cloud computing platform.

15. A computer program product for causing one or more processor to:
access internal bank data for a customer, where the internal bank data includes at least one of credit card transactions, debit account transactions, credit memos, or customer identifying information for the customer;
execute one or more operations that use at least one of the credit card transactions, the debit account transactions, or the credit memos to identify sources of carbon emissions for a location corresponding to the customer;
access satellite imagery, soil quality maps, climate maps, agricultural-marketer data, and business information to estimate a total area under cultivation and a crop mix for the location corresponding to the customer;
receive a graphical user interface that is prepopulated with estimates that identify sources of carbon emissions; and
apply the internal bank data, the estimate of the total area under cultivation, and the estimate of the crop mix to a carbon calculator to provide carbon emission estimates.

16. The computer program product of claim 15, further comprising instructions to cause the one or more processor to:
receive inputs that update sources of carbon emissions.

17. The computer program product of claim 16, further comprising instructions to cause the one or more processor to:
apply the received inputs to the internal bank data, the estimate of total area under cultivation, and the estimate of the crop mix to provide carbon emission estimates.

18. The computer program product of claim 17, wherein the provided carbon emission estimates and the estimate of the crop mix are packaged in a customer carbon profile data structure.

19. The computer program product of claim 18, wherein data from the customer carbon profile data structure are rendered in the graphical user interface.

20. The computer program product of claim 19, wherein the graphical user interface depicts crops planted and acreage planted for the crops.
